(19) United States
(12) Patent Application Publication
(10) Pub. No.: US 2009/0244559 A1
(43) Pub. Date: Oct. 1, 2009

(54) IMAGE RASTERIZING APPARATUS AND IMAGE RASTERIZING METHOD

(75) Inventors: Shunichi Megawa, Tagata-gun (JP); Yuusuke Suzuki, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/054,607

(22) Filed: Mar. 25, 2008

(51) Int. Cl. G06F 3/12

(52) U.S. Cl. 358/1.9

(57) ABSTRACT

An image rasterizing apparatus according to the invention includes: an input unit configured to input an image file or image file information including first bitmap images that are drawn in accordance with a command and have different image attributes; a bitmap image generating unit configured to create a second bitmap image at least from the first bitmap image; and an attribute signal generating unit configured to search attribute information held by the first bitmap image on the basis of the command, then decide a data format of the first bitmap image in accordance with the attribute information, and generate an attribute signal indicating the decided data format. With the image rasterizing apparatus according to the invention, different attribute signals can be outputted in accordance with image attributes, from an image file including bitmap data having different image attributes.

### BACKGROUND OF THE INVENTION

1. Technical Field of the Invention

The present invention relates to an image rasterizing technique, and particularly to an image rasterizing apparatus and an image rasterizing method that enable print output of a document file including bitmap images of plural formats such as PDF, XML and HTML.

2. Related Art

A method is known in which image processing is switched between characters and line drawings, and natural images, in order to provide high print image quality in the case of printing out an image by a copy machine or printer. Specifically, a method is known in which image processing such as halftone processing is switched in accordance with the image attribute in order to emphasize reproduction of resolution for characters and line drawings and to emphasize reproduction of gradation for natural images.

As a conventional technique of switching image processing, for example, a method is disclosed in JP-A-2000-148973 in which when a bitmap image generating unit generates and prints out a bitmap image (second bitmap image) based on the page description language of an original image (first image), it is determined which of “natural image” and “graphic or character” the image attribute of the second bitmap image corresponds to, in accordance with which of bitmap data command and vector data command the page description language has, and this image attribute is outputted as attribute information.

As an image processing system that outputs such attribute information, a system having a bitmap image generating unit, an attribute signal generating unit and an image processing unit is typically used.

That is, in the above image processing system, first, an image file that is outputted from an application and includes one or two or more first images, is converted into a page description language by a printer driver, and then this page description language is inputted to a raster image processor (RIP) having the bitmap image generating unit and the attribute signal generating unit.

Next, in the raster image processor, the bitmap image generating unit rasterizes a command set of page description language to create a second bitmap image. Meanwhile, the attribute signal generating unit creates and outputs an attribute signal indicating which of a font, vector and bitmap command the second bitmap image is generated by.

The second bitmap image and the attribute signal outputted from the raster image processor are inputted to the image processing unit. At the image processing unit, image processing of the second bitmap image is switched in accordance with the type of the attribute signal.

FIG. 14 shows an example of switching of image processing at the image processing unit.

As shown in FIG. 14, when the method described in JP-A-2000-148973 is used, image processing of the second bitmap image can be changed in accordance with which of character, graphic and natural image the image attribute of the second bitmap image corresponds to. Therefore, appropriate image processing corresponding to the image attribute of each second bitmap image can be carried out.

However, in the method described in JP-A-2000-148973, in the case where the first image is an image file inputted by being scanned, since the entire first image including characters and figures is formed by bitmap data, like a natural image, it is impossible to switch image processing. Therefore, appropriate image processing corresponding to the image attribute of each second bitmap image cannot be carried out.

Meanwhile, as an image reproduction method with high compression and high image quality, for example, an expression method has recently been known in which an input image is divided into a character area of bitmap data and a natural image area of bitmap data so that the character area is binarized and then MMR-compressed, whereas the natural image area is JPEG-compressed, thereby performing high compression of the natural image while maintaining the image quality of the character area, and thus expressing a full-color image with a small data size. Hereinafter, this expression method is referred to as “bitmap data expression method”.

In the bitmap data expression method, an entire first image in an image file is expressed in the form of bitmap data (first bitmap image) irrespective of whether it is a character area or a natural image area. Therefore, the page description language acquired by converting this first bitmap image contains only the information of the bitmap data.

Thus, when the image processing method described in JP-A-2000-148973 is used for an image file created by the bitmap data expression method, it is simply expressed as bitmap data in the attribute signal, whether the image attribute of the second bitmap image acquired by rasterizing the page description language corresponds to character, graphic, or natural image. Therefore, appropriate image processing corresponding to the image attribute of each second bitmap image cannot be carried out.

FIG. 15 shows an example of switching image processing at the image processing unit in the case where the image processing method described in JP-A-2000-148973 is used.

As shown in FIG. 15, when the image processing method described in JP-A-2000-148973 is used, processing of bitmap data is collectively carried out as image processing of the second bitmap image, whether the image attribute of the second bitmap image corresponds to character, graphic, or natural image.

Thus, appropriate image processing corresponding to the image attribute of each second bitmap image cannot be carried out by the image processing method described in JP-A-2000-148973. For example, for a second bitmap image of a character area part, the same image processing as for a second bitmap image of a natural image area is carried out, and therefore its image quality is lowered.

To deal with this, a method is disclosed in JP-A-2005-39430 in which image identification processing is performed to a generated second bitmap image to acquire a correct attribute signal. However, this identification processing takes time and also has a problem that an identification error may occur.

### SUMMARY OF THE INVENTION

In view of the foregoing circumstances, it is an object of the invention to provide an image rasterizing apparatus in which, from an image file including bitmap data that is drawn in accordance with a command and has different image attributes, different attribute signals can be outputted in accordance with image attributes, and in which there is no risk of occurrence of an identification error of an image attribute.

To achieve the above object, an image rasterizing apparatus according to an aspect of the invention includes: an input unit configured to input an image file including plural first bitmap images having different image attributes or image file information acquired by converting the image file, the plural first bitmap images being drawn in accordance with a command; a bitmap image generating unit configured to create a second bitmap image at least from the first bitmap image; and an attribute signal generating unit configured to search attribute information held by the first bitmap image on the basis of the command, then decide which data format of font data, vector data and bitmap data the first bitmap image corresponds to, in accordance with the attribute information, and generate an attribute signal indicating the decided data format.

Also, to achieve the above object, an image rasterizing method according to another aspect of the invention includes: inputting, by an input unit, an image file including plural first bitmap images having different image attributes or image file information acquired by converting the image file, the plural first bitmap images being drawn in accordance with a command; by a bitmap image generating unit, treating a second bitmap image at least from the first bitmap image; and by an attribute signal generating unit, searching attribute information held by the first bitmap image on the basis of the command, then deciding which data format of font data, vector data and bitmap data the first bitmap image corresponds to, in accordance with the attribute information, and generating an attribute signal indicating the decided data format.

### BRIEF DESCRIPTION OF THE DRAWINGS

In the attached drawings,

FIG. 1 is a functional block diagram of an image processing system including an image rasterizing apparatus according to the invention;

FIG. 2 is a view showing an exemplary input image file including two bitmap data (first bitmap images) drawn in accordance with a command and having different image attributes;

FIG. 3 is a view showing an exemplary command set to draw each bitmap data (first bitmap image) of the input image file shown in FIG. 2;

FIG. 4 is a view showing an exemplary raster image file including a bitmap image (second bitmap image) rasterized from the page description language shown in FIG. 3;

FIG. 5 is a view conceptually showing an exemplary attribute signal file including an attribute signal generated from the page description language shown in FIG. 3;

FIG. 6 is a view showing an example of switching image processing;

FIG. 7 is a flowchart showing the operation of the image rasterizing apparatus according to the invention;

FIG. 8 is a view showing an exemplary input image file including two bitmap data (first bitmap images) drawn in accordance with a command and having difference image attributes;

FIG. 9 is a view showing an exemplary command set to draw each bitmap data (first bitmap image) of the input image file shown in FIG. 8;

FIG. 10 is a view showing an exemplary raster image file including a bitmap image (second bitmap image) rasterized from the page description language shown in FIG. 9;

FIG. 11 is a view conceptually showing an exemplary attribute signal file including an attribute signal generated from the page description language shown in FIG. 9;

FIG. 12 is a view showing an exemplary raster image file including a bitmap image (second bitmap image) rasterized from the page description language shown in FIG. 9;

FIG. 13 is a view conceptually showing an exemplary attribute signal file including an attribute signal generated from the page description language shown in FIG. 9;

FIG. 14 is a view showing a conventional example of switching image processing; and

FIG. 15 is a view showing a conventional example of switching image processing.

### DETAILED DESCRIPTION OF THE PREFERRED EMBODIMENTS

Embodiments of an image rasterizing apparatus according to the invention will be described with reference to the attached drawings.

### First Embodiment

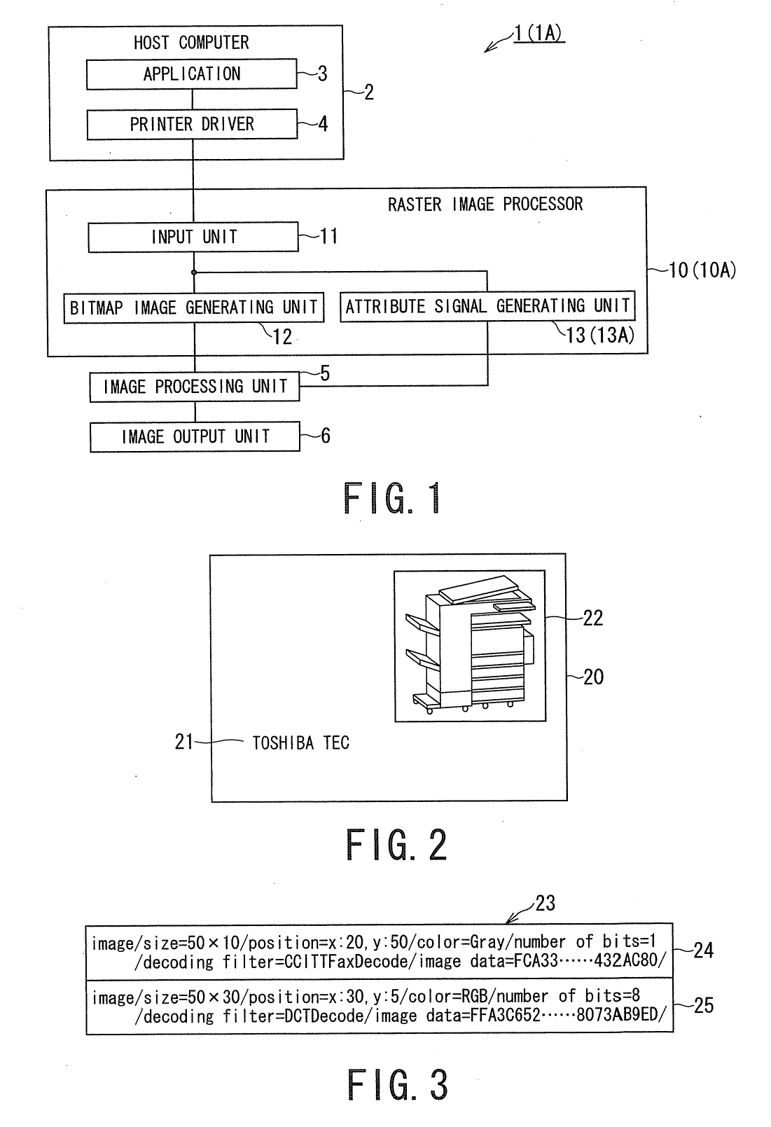

FIG. 1 is a functional block diagram of an image processing system 1 including an image rasterizing apparatus 10 according to the invention.

The image processing system 1 includes a host computer 2, the image rasterizing apparatus (raster image processor (RIP)) 10, an image processing unit 5, and an image output unit 6. The host computer 2 has an application 3 and a printer driver 4. The printer driver 4 is connected to an input unit 11 of the image rasterizing apparatus 10.

The application 3 is, for example, word processing software, presentation software, web browser and so on.

The printer driver 4 converts an image file into a page description language (PDL) that can be printed by a printer, when outputting an image file including characters, graphics and bitmap data created by the application 3 to the printer. As the page description language, for example, postscript may be used.

The image rasterizing apparatus 10 has the input unit 11, a bitmap image generating unit 12 and an attribute signal generating unit 13. The bitmap image generating unit 12 and the attribute signal generating unit 13 are connected to the input unit 11.

The input unit 11 inputs an image file including plural first bitmap images having different image attributes or image file information acquired by converting this image file.

A first bitmap image refers to a bitmap image that is drawn in accordance with a command and included in an image file.

An image file includes plural first bitmap images having different image attributes. An image file may include font data and vector data other than first bitmap images.

As a form of image file that includes plural first bitmap images having different image attributes, for example, plural first bitmap images compressed in accordance with various compression formats such as MMR, JBIG2, JPEG and JPEG2000 maybe included in an image file.

As the image file, for example, a PDF file, XML file or HTML file may be employed.

As the image file information, for example, a page description language (PDL) that is created by conversion or the like of an image file by a printer driver and includes a command of bitmap data may be employed.

In the image processing system 1, the input unit 11 of the image rasterizing apparatus 10 is connected to the printer driver 4 of the host computer 2. The page description language as the image file information is inputted the input unit 11.

Alternatively, instead of being connected to the printer driver 4, the input unit 11 may be connected to a input unit, not shown, that inputs an image file such as a PDF file, XML file or HTML file.

An image file including plural first bitmap images having different image attributes, which is inputted to the input unit 11, will be described with reference to the drawings.

FIG. 2 is a view showing an exemplary input image file including two bitmap data (first bitmap images) having different image attributes.

An input image file 20 shown in FIG. 2 includes two bitmap data having different image attributes, that is, MMR-compressed bitmap data (first bitmap image) 21 and JPEG-compressed bitmap data (first bitmap image) 22.

The first bitmap image 21 is an example of bitmap data which expresses, for example, characters “TOSHIBA TEC” showing the company name “TOSHIBA TEC”.

The first bitmap image 22 represents an example of bitmap data which expresses a photograph of a copy machine. Although the first bitmap image 22 is a photographic image, it is schematically shown in FIG. 2.

The bitmap image generating unit 12 creates a second bitmap image from image data in the image file.

Here, a second bitmap image refers to a bitmap image acquired by rasterizing image data included in an image file. As the image data included in the image file, at least a first bitmap image may be employed. The image data included in the image file may also include font data and vector data in addition to the first bitmap image.

In the case of rasterizing a second bitmap image from a first bitmap image, the bitmap image generating unit 12 creates the second bitmap image from the first bitmap image in accordance with a command to draw the first bitmap image.

Meanwhile, in the case of rasterizing a second bitmap image from font data or vector data, the bitmap image generating unit 12 creates the second bitmap image from the font data or vector data in accordance with a command to create the font data or vector data.

In the image file, the command to draw the first bitmap image is attached to the first bitmap image included, for example, in a PDF file. In the image file information, the command is expressed in a page description language, for example.

A command to draw a first bitmap image will be described with reference to the drawings.

FIG. 3 is a view showing an exemplary command set in the page description language to draw each bitmap data (first bitmap image) of the input image file shown in FIG. 2.

A command set 23 in the page description language shown in FIG. 3 includes a command 24 to draw the MMR-compressed first bitmap image 21 and a command 25 to draw the JPEG-compressed first bitmap image 22.

In the command 24 to draw the MMR-compressed first bitmap image 21, for example, the position information of x equal to 20 and y equal to 50, the number of bits “1”, the decoding filter “CCITTFaxDecode” indicating the difference in the image coding method, and the color “Gray” are described as attribute information of the command.

Meanwhile, in the command 25 to draw the JPEG-compressed first bitmap image 22, for example, the position information of x equal to 30 and y equal to 5, the number of bits “8”, the decoding filter “DCTDecode” indicating the difference in the image coding method, and the color “RGB” are described as attribute information of the command.

In accordance with the command 24 and the command 25, the bitmap image generating unit 12 creates a second bitmap image from each of the first bitmap image 21 and the first bitmap image 22.

A second bitmap image will be described with reference to the drawings.

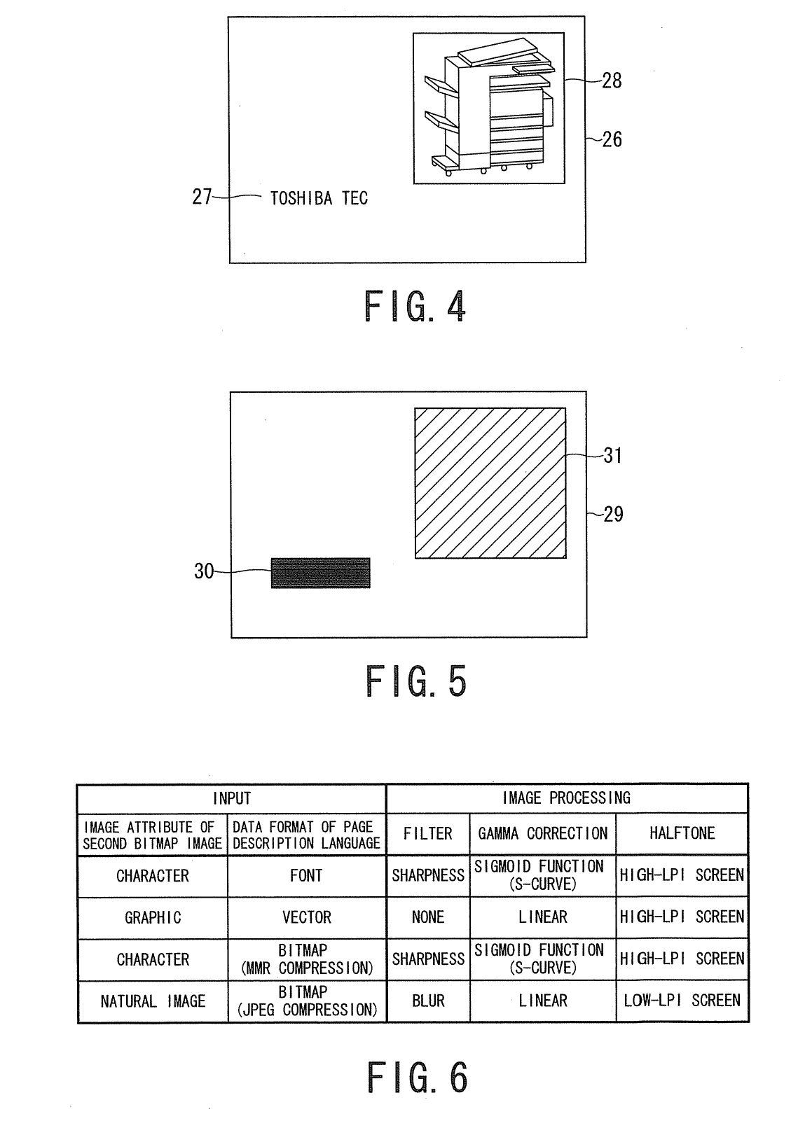

FIG. 4 is a view showing an exemplary raster image file 26 including a bitmap image (second bitmap image) rasterized from the page description language shown in FIG. 3.

The raster image file 26 shown in FIG. 4 includes a second bitmap image 27 rasterized from the first bitmap image 21 shown in FIG. 2 and a second bitmap image 28 rasterized from the first bitmap image 22 shown in FIG. 2.

The second bitmap image 27 is an example of bitmap data expressing characters “TOSHIBA TEC”. The second bitmap image 28 is an example of bitmap data expressing a photograph of a copy machine. Although the second bitmap image 28 is a photographic image, it is schematically shown in FIG. 4.

The attribute signal generating unit 13 searches attribute information held by the first bitmap image, then decides which data format of font data, vector data and bitmap data the first bitmap image corresponds to, in accordance with this attribute information, and generates an attribute signal indicating the decided data format.

Specifically, the attribute signal generating unit 13 first searches the attribute information held by the first bitmap image from the command to draw the first bitmap image.

Next, the attribute signal generating unit 13 applies this attribute information to a correspondence table that predefines the corresponding relation between attribute information and data formats of font data, vector data and bitmap data. The attribute signal generating unit 13 thus decides which data format of font data, vector data and bitmap data the first bitmap image corresponds to.

Moreover, the attribute signal generating unit 13 generates an attribute signal indicating this decided data format.

Here, attribute information refers to information representing the number of bits, the difference in the image coding method, the color mode, or the quantity of codes, described in a command.

Attribute information will be described with reference to FIG. 3.

In the command 24 to draw MMR-compressed first bitmap image 21, for example, the number of bits “1”, the decoding filter “CCITTFaxDecode” indicating the difference in the image coding method, and the color “Gray” are described as attribute information of the command.

Meanwhile, in the command 25 to draw the JPEG-compressed first bitmap image 22, for example, the number of bits “8”, the decoding filter “DCTDecode” indicating the difference in the image coding method, and the color “RGB” are described as attribute information of the command.

The correspondence table that predefines the corresponding relation between attribute information and data formats of font data, vector data and bitmap data is to decide which data format of font data, vector data and bitmap data the first bitmap image corresponds to, in accordance with the content of the attribute information.

In the case where the above correspondence table predefines the corresponding relation between the number of bits as attribute information and data format, the above correspondence table is set to determine that, for example, if the number of bits of the first bitmap image is 1, it is font data, and if the number of bits is 2 to 8, it is vector data, and if the number of bits is 9 or more, it is bitmap data. The numbers of bits corresponding to data formats can be suitably defined.

Meanwhile, in the case where the above correspondence table predefines the corresponding relation between the image coding method as attribute information and data format, the above correspondence table is set to determine that, for example, if the image coding method is MMR, it is font data, and if the image coding method is JPEG, it is bitmap data. The types of image coding methods corresponding to data formats can be suitably defined.

Moreover, in the case where the above correspondence table predefines the corresponding relation between the color mode as attribute information and data format, the above correspondence table is set to determine that, for example, if the color mode is “Gray”, it is font data, and if the color mode is “index color”, it is vector data, and if the color mode is “RGB”, it is bitmap data. The types of color modes corresponding to data formats can be suitably defined.

Furthermore, in the case where the above correspondence table predefines the corresponding relation between the quantity of codes as attribute information and data format, the above correspondence table is set to determine that, for example, if the quantity of codes has a predetermined value or less, it is font data, and if the quantity of codes exceeds the predetermined value, it is bitmap data. The threshold value of the quantity of codes corresponding to data formats can be suitably defined.

When the correspondence table that defines the corresponding relation between the quantity of codes and data format is used, for example, discrimination between binary images is possible, that is, between a binary image having a character attribute and a binary image acquired by dither processing of a photograph.

That is, since both a binary image having a character attribute and a binary image acquired by dither processing of a photograph have the same number of bits, that is, 1 bit, the two binary images cannot be discriminated on the basis of the number of bits. However, since a binary image acquired by dither processing of a photograph generally has a greater quantity of codes than a binary image having a character attribute, the two binary images can be discriminated on the basis of the difference in the quantity of codes.

An attribute signal is a signal indicating information about which data format of font data, vector data and bitmap data the image attribute of image data included in an image file corresponds to.

In the case where the image data included in the image file is a first bitmap image, the attribute signal generating unit 13 generates an attribute signal after it is decided which data format of font data, vector data and bitmap data the first bitmap image corresponds to.

In the case where the image data included in the image file is font data or vector data, it is already known that the image attribute of the image data is “font” or “vector”. Therefore, in the case where the image data included in the image file is font data or vector data, the attribute signal generating unit 13 generates an attribute signal indicating that the attribute is “font” or “vector”, without using the correspondence table that predefines the corresponding relation between attribute information and data format.

The attribute signal generating unit 13 further generates an attribute signal file including attribute signals, in addition to a raster image file.

An attribute signal file will be described with reference to the drawings.

FIG. 5 is a view showing an exemplary attribute signal file 29 rasterized from the page description language 23 shown in FIG. 3.

The attribute signal file 29 shown in FIG. 5 includes two attribute signals, that is, an attribute signal 30 formed at the part corresponding to the second bitmap image 27, and an attribute signal 31 formed at the part corresponding to the second bitmap image 28.

In the attribute signal file 29, the attribute signal 30 and the attribute signal 31 are provided at the positions shown in FIG. 5. However, this is a conceptual expression, which is not actually displayed as shown in FIG. 5.

Each of the bitmap image generating unit 12 and the attribute signal generating unit 13 of the image rasterizing apparatus 10 is connected to the image processing unit 5.

The image processing unit 5 switches image processing such as filter processing or halftone processing in accordance with the attribute signal with respect to the second bitmap image created by the image rasterizing apparatus 10, and thus performs appropriate image processing corresponding to the attribute of each second bitmap image.

FIG. 6 shows an example of switching image processing at the image processing unit 5. In FIG. 6, a first column, which is the first from the left, shows the type of the attribute signal of the second bitmap image inputted to the image processing unit 5. A second column, which is the second from the left, shows the data format in the page description language that has served as the base of creating the attribute signal.

In FIG. 6, a third column, which is the third from the left, shows the filter system. A fourth column, which is the fourth from the left, shows the gamma correction system. A fifth column, which is the fifth from the left, shows the halftone processing system.

In FIG. 6, for the second row from the bottom, “character” is described in the first column and “bitmap (MMR compression)” is described in the second column. This indicates image processing of the second bitmap image 27 shown in FIG. 4.

In FIG. 6, for the bottom row, “natural image” is described in the first column. This indicates image processing of the second bitmap image 28 shown in FIG. 4.

In FIG. 6, for the fourth row from the bottom, “font” instead of “bitmap (MMR compression)” is described in the second column. Therefore, the second bitmap image corresponding to the fourth row from the bottom has not been created from the first bitmap image but has been created from a page description language acquired by converting font data.

The fourth row from the bottom does not indicate image processing of the second bitmap image 27 shown in FIG. 4. However, this is an example indicating that image processing can be switched even for a second bitmap image created from a page description language acquired by converting font data.

In FIG. 6, for the third row from the bottom, “vector” is described in the second column. The second bitmap image corresponding to the third row from the bottom has not been created from the first bitmap image but has been created from a page description language acquired by converting vector data.

The third row from the bottom does not indicate image processing of the second bitmap image 27 shown in FIG. 4. However, this is an example indicating that image processing can be switched even for a second bitmap image created from a page description language acquired by converting vector data.

As shown in FIG. 6, the image processing unit 5 changes image processing of the second bitmap image as shown in the third to fifth columns in accordance with which of character, graphic and natural image the attribute signal inputted to the image processing unit 5 corresponds to. Therefore, image processing suitable for the image attribute of the second bitmap image can be carried out.

The image processing unit 5 is connected to the image output unit 6. An image is outputted from the image output unit 6. The image output unit 6 is an electrophotographic or inkjet printer and records image data outputted from the image processing unit 5 onto a paper.

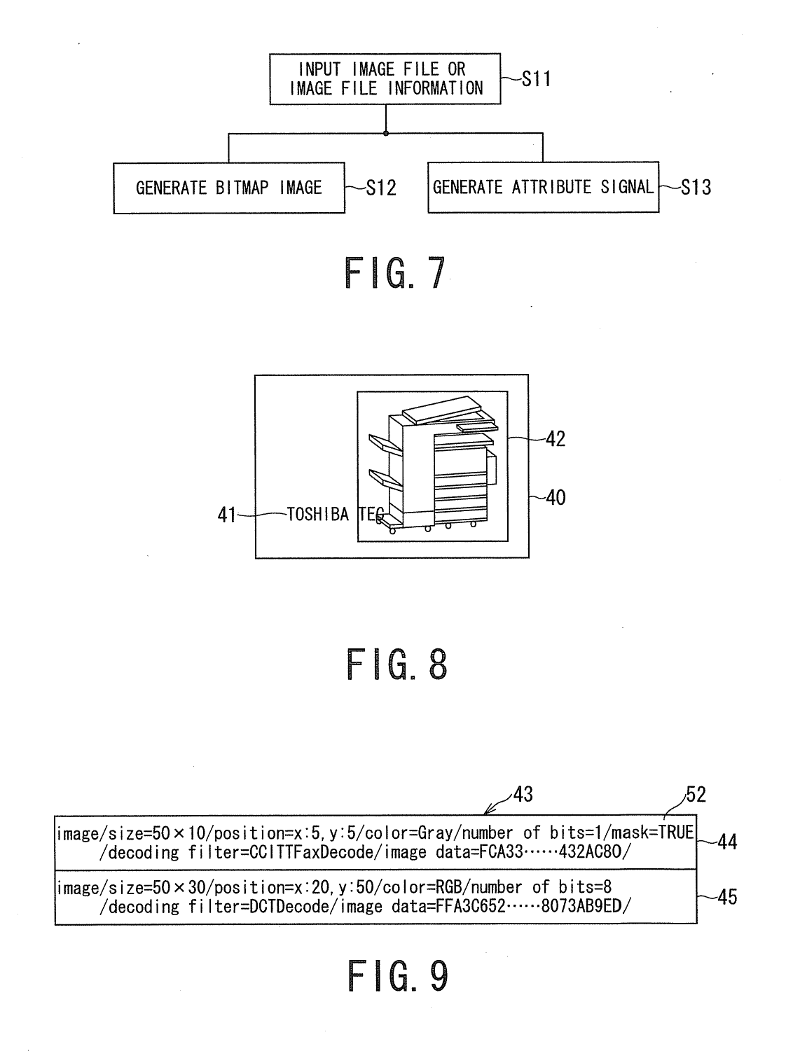

Next, the operation of the image rasterizing apparatus 10 according to the invention will be described. FIG. 7 is a flowchart showing the operation of the image rasterizing apparatus 10 according to the invention.

In an input step, the input unit 11 inputs an image file including plural first bitmap images having different image attributes or image file information acquired by converting this image file. The plural first bitmap images are drawn in accordance with a command (step S11).

After step S11, in an image generation step, the bitmap image generating unit 12 creates a second bitmap image at least from a first bitmap image in accordance with a command to draw the first bitmap image (step S12).

After step S11, in an attribute signal generation step, the attribute signal generating unit 13 first searches attribute information held by the first bitmap image from the command to draw the first bitmap image.

Next, the attribute signal generating unit 13 applies this attribute information to a correspondence table that predefines the corresponding relation between attribute information and data formats of font data, vector data and bitmap data, and decides which data format of font data, vector data or bitmap data the first bitmap image corresponds to.

Moreover, the attribute signal generating unit 13 generates an attribute signal indicating this decided data format (step S13).

In the case where the image file includes font data and vector data in addition to the first bitmap image, the attribute signal generating unit 13 creates an attribute signal of a second bitmap image created from this font data and vector data in a separate step from step S13.

For the second bitmap image and attribute signal created after step S12 and step S13, image processing is carried out by the image processing unit 5, and after that, a processed image is outputted from the image output unit 6.

The advantages of the image rasterizing apparatus 10 and its image rasterizing method described in the first embodiment will be described.

With the image rasterizing apparatus 10 and its image rasterizing method described in the first embodiment, it is possible to output different attribute signals in accordance with image attributes, from an image file including bitmap data having different image attributes and drawn in accordance with a command. Also, since identification processing is not executed on bitmap images, the processing time is short and there is no risk that identification errors occur.

### Second Embodiment

Next, the second embodiment of the image rasterizing apparatus according to the invention will be described with reference to FIG. 1 and FIG. 8 to FIG. 13.

An image rasterizing apparatus 10A described in the second embodiment uses an attribute signal generating unit 13A instead of the attribute signal generating unit 13 of the image rasterizing apparatus 10. Since the other parts of the configuration and operation are similar to those of the image rasterizing apparatus 10 described in the first embodiment, the description of the same configuration and operation will be suitably simplified or omitted.

The image rasterizing apparatus 10A is the same as the image rasterizing apparatus 10 except for the use of the attribute signal generating unit 13A instead of the attribute signal generating unit 13, and the use of an image processing system 1A instead of the image processing system 1. Therefore, the functional block diagram of the image rasterizing apparatus 10A is shown in FIG. 1, similarly to the functional block diagram of the image rasterizing apparatus 10.

The attribute signal generating unit 13A generates an attribute signal further including mask image information in the case where the mask image information exists in a command to draw a first bitmap image, in addition to the similar operation to the attribute signal generating unit 13.

Here, mask image information is the information of a mask image. A mask image is a binary bitmap image in which transmission or non-transmission can be selected in a character part and in a background part of an image. A mask image is usually set in such a manner that a character part becomes a non-transmission part and a background part becomes a transmission part.

Mask image information is described in a command to draw a first bitmap image.

An example in which mask image information is described in a command to draw a first bitmap image will be described with reference to the drawings.

FIG. 8 is a view showing an exemplary input image file including two bitmap data (first bitmap images) having different image attributes.

An input image file 40 shown in FIG. 8 includes two bitmap data having different image attributes, that is, MMR-compressed bitmap data (first bitmap image) 41 and JPEG-compressed bitmap data (first bitmap image) 42.

The first bitmap image 41 is an example of bitmap data which expresses, for example, characters “TOSHIBA TEC” showing the company name “TOSHIBA TEC”.

The first bitmap image 42 represents an example of bitmap data which expresses a photograph of a copy machine. Although the first bitmap image 42 is a photographic image, it is schematically shown in FIG. 8.

In the input image file 40, the first bitmap image 41 and the first bitmap image 42 partly overlap each other. The first bitmap image 41 is a mask image in which the background part is transmitted.

FIG. 9 is a view showing an exemplary command set in a page description language to draw each bitmap data (first bitmap image) of the input image file shown in FIG. 8.

A command set 43 in the page description language shown in FIG. 9 includes a command 44 to draw the MMR-compressed first bitmap image 41 and a command 45 to draw the JPEG-compressed first bitmap image 42.

In the command 44 to draw the MMR-compressed first bitmap image 41, for example, the position information of x equal to 5 and y equal to 5, the number of bits “1”, the decoding filter “CCITTFaxDecode” indicating the difference in the image coding method, and the color “Gray” are described as attribute information of the command.

Moreover, in the command 44, the mask “TRUE” is described as mask image information 52 indicating that the first bitmap image 41 is a mask image.

Meanwhile, the command 45 to draw the JPEG-compressed first bitmap image 42 is the same as the command 25 except for the position information (x being 20, y being 50) and therefore will not be described further in detail.

In accordance with the command 44 and the command 45, the bitmap image generating unit 12 creates a second bitmap image from each of the first bitmap image 41 and the first bitmap image 42.

A second bitmap image will be described with reference to the drawings.

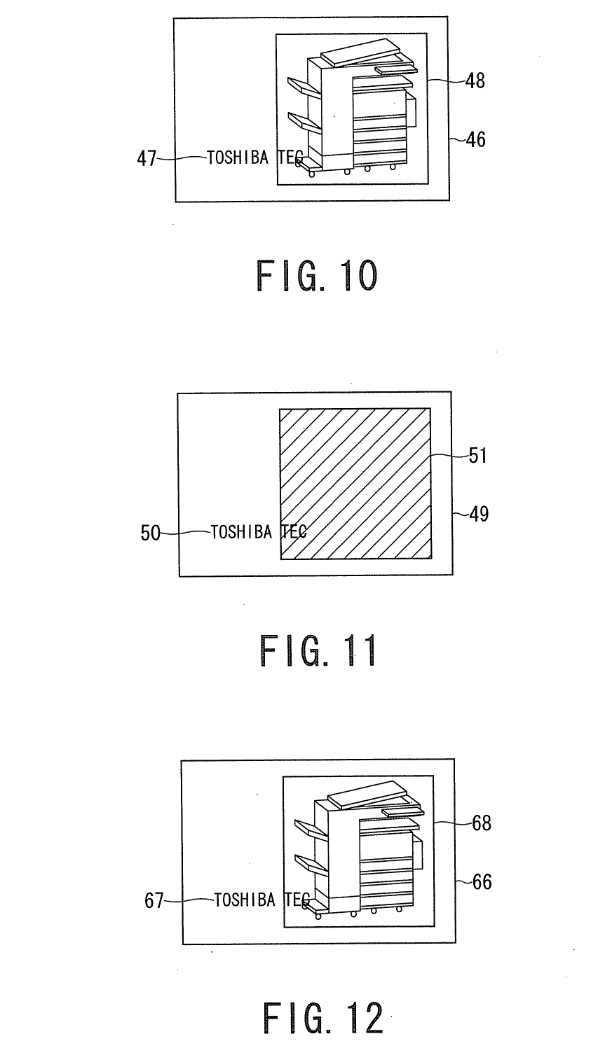

FIG. 10 is a view showing an exemplary raster image file 46 including a second bitmap image rasterized from the page description language 43 shown in FIG. 9.

The raster image file 46 shown in FIG. 10 includes a second bitmap image 47 rasterized from the first bitmap image 41 shown in FIG. 8 in accordance with the page description language 43 shown in FIG. 9 and a second bitmap image 48 rasterized from the first bitmap image 42 shown in FIG. 8 in accordance with the page description language 43 shown in FIG. 9.

The second bitmap image 47 is an example of bitmap data expressing characters “TOSHIBA TEC”. The second bitmap image 48 is an example of bitmap data expressing a photograph of a copy machine. Although the second bitmap image 48 is a photographic image, it is schematically shown in FIG. 10.

In the raster image file 46, the second bitmap image 47 and the second bitmap image 48 partly overlap each other. The second bitmap image 47 is a mask image in which the background part is transmitted.

The attribute signal generating unit 13A generates an attribute signal further including mask image information of the command to draw the first bitmap image, as described above. Therefore, the mask image information 52 is appended to the attribute signal created by the attribute signal generating unit 13A, in addition to the attribute information, for example, the number of bits, image coding method and so on.

FIG. 11 is a view showing an exemplary attribute signal file 49 rasterized from the page description language 43 shown in FIG. 9.

The attribute signal file 49 shown in FIG. 11 includes two attribute signals, that is, an attribute signal 50 formed in the part corresponding to the second bitmap image 47 and an attribute signal 51 formed in the part corresponding to the second bitmap image 48.

In the attribute signal file 49, the attribute signal 50 and the attribute signal 51 are provided at the positions shown in FIG. 11. However, this is a conceptual expression, which is not actually displayed as shown in FIG. 11.

The mask image information 52 is described in the attribute signal 50. Therefore, when the attribute signal file 49 including the attribute signal 50 is inputted to the image processing unit 5 together with the raster image file 46, the second bitmap image 47 in the raster image file 46 located at the position corresponding to the position of the attribute signal 50 in the attribute signal file 49 is recognized as a mask image and appropriate image processing is carried out. Thus, a printer output with high image quality is possible.

The operation of the image rasterizing apparatus 10A according to the invention is the same as the operation of the image rasterizing apparatus 10 except for creating the attribute signal further including the mask image information 52 in addition to the other attribute information in the attribute signal generation step (step S13). Therefore, it will not be described further in detail.

The advantages of the image rasterizing apparatus 10A and the image rasterizing method using the image rasterizing apparatus 10A described in the second embodiment will be described.

With the image rasterizing apparatus 10A and the image rasterizing method using the image rasterizing apparatus 10A described in the second embodiment, even when a character is arranged to overlap a natural image, an image acquired by image processing can have a character attribute only for the character part in the character area processed by MMR coding or the like and can have an attribute such that the background part in the character area can be transmitted, in addition to the advantages of the image rasterizing apparatus 10 and the image rasterizing method using the image rasterizing apparatus 10.

Unlike the image rasterizing apparatus 10A, when an attribute signal is generated in the image rasterizing apparatus 10 described in the first embodiment, the mask image information 52 is not included in the generated attribute signal.

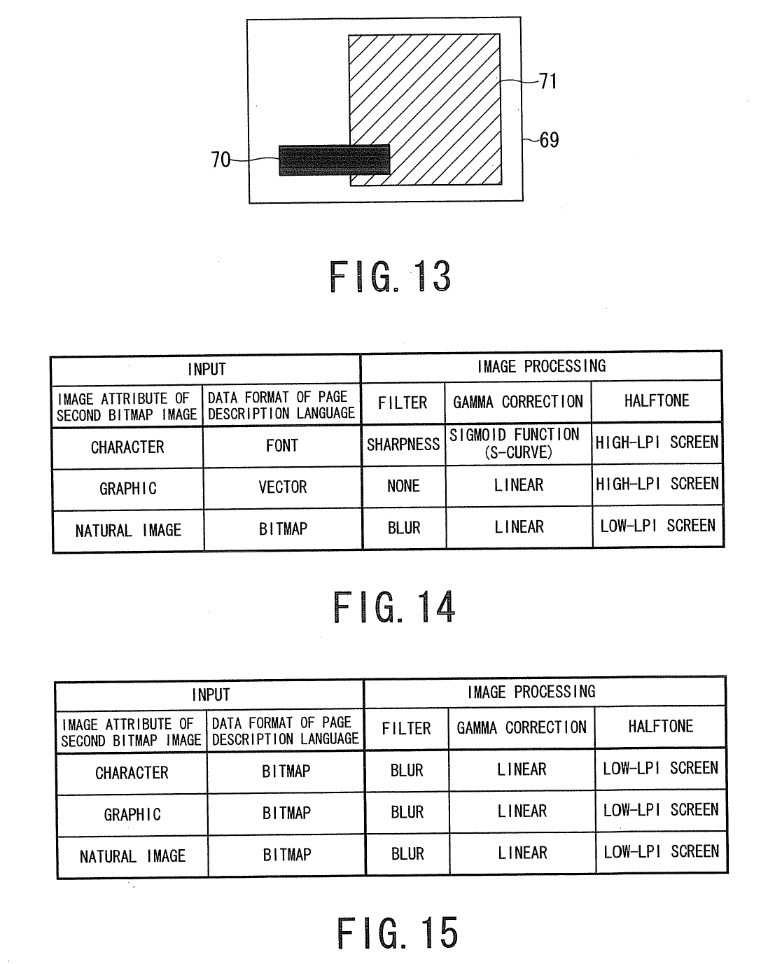

The non-inclusion of the mask image information 52 in the attribute signal created in the image rasterizing apparatus 10 will be described with reference to FIG. 12 and FIG. 13.

FIG. 12 is a view showing an exemplary raster image file 66 including second bitmap images 67 and 68 rasterized from the page description language 43 shown in FIG. 9 by using the image rasterizing apparatus 10.

The raster image file 66 shown in FIG. 12 includes two bitmap images, that is, the second bitmap image 67 rasterized from the first bitmap image 41 shown in FIG. 8 in accordance with the page description language 43 shown in FIG. 9 and the second bitmap image 68 rasterized from the first bitmap image 42 shown in FIG. 8 in accordance with the page description language 43 shown in FIG. 9.

The second bitmap image 67 is an example of bitmap data expressing characters “TOSHIBA TEC”. The second bitmap image 68 is an example of bitmap data expressing a photograph of a copy machine. Although the second bitmap image 68 is a photographic image, it is schematically shown in FIG. 12.

In the raster image file 66, the second bitmap image 67 and the second bitmap image 68 partly overlap each other. The second bitmap image 67 is a mask image in which the background part is transmitted.

FIG. 13 is a view showing an exemplary attribute signal file 69 rasterized from the page description language 43 shown in FIG. 9 by using the image rasterizing apparatus 10 described in the first embodiment.

The attribute signal file 69 shown in FIG. 13 includes two attribute signals, that is, an attribute signal 70 formed in the part corresponding to the second bitmap image 67 and an attribute signal 71 formed in the part corresponding to the second bitmap image 68.

In the attribute signal file 69, the attribute signal 70 and the attribute signal 71 are provided at the positions shown in FIG. 13. However, this is a conceptual expression, which is not actually displayed as shown in FIG. 13.

Unlike the attribute signal 50 created by using the image rasterizing apparatus 10A, the mask image information 52 is not described in the attribute signal 70.

Therefore, even when the attribute signal file 69 including the attribute signal 70 is inputted to the image processing unit 5 together with the raster image file 66, the second bitmap image 67 in the raster image file 66 is not recognized as a mask image. Therefore, appropriate image processing is not carried out and it is difficult to provide a printer output with high image quality.

On the other hand, with the image rasterizing apparatus 10A having the attribute signal generating unit 13A, the second bitmap image 47 in the raster image file 46 is recognized as a mask image and appropriate image processing is carried out. Thus, it is possible to provide a printer output with high image quality.

What is claimed is:

1. An image rasterizing apparatus comprising:
an input unit configured to input an image file including plural first bitmap images having different image attributes or image file information acquired by converting the image file, the plural first bitmap images being drawn in accordance with a command;
a bitmap image generating unit configured to create a second bitmap image at least from the first bitmap image; and
an attribute signal generating unit configured to search attribute information held by the first bitmap image on the basis of the command, then decide which data format of font data, vector data and bitmap data the first bitmap image corresponds to, in accordance with the attribute information, and generate an attribute signal indicating the decided data format.

2. The image rasterizing apparatus according to claim 1, wherein the attribute signal generating unit decides which data format of font data, vector data and bitmap data the first bitmap image corresponds to, by applying the searched attribute information to a correspondence table that predefines corresponding relation between attribute information and data formats of font data, vector data and bitmap data.

3. The image rasterizing apparatus according to claim 1, wherein the image file information is a page description language which is created from the image file and includes a command of bitmap data, and
the command is a command included in the page description language.

4. The image rasterizing apparatus according to claim 1, wherein in the case where mask image information exists in the command, the attribute signal generating unit generates the attribute signal further including the mask image information.

5. The image rasterizing apparatus according to claim 1, wherein the attribute information is the number of bits, and
in the case where mask image information exists in the command, the attribute signal generating unit generates the attribute signal further including the mask image information.

6. The image rasterizing apparatus according to claim 1, wherein the attribute information is an image coding method, and
in the case where mask image information exists in the command, the attribute signal generating unit generates the attribute signal further including the mask image information.

7. The image rasterizing apparatus according to claim 1, wherein the attribute information is a color mode, and
in the case where mask image information exists in the command, the attribute signal generating unit generates the attribute signal further including the mask image information.

8. The image rasterizing apparatus according to claim 1, wherein the attribute information is the quantity of codes, and
in the case where mask image information exists in the command, the attribute signal generating unit generates the attribute signal further including the mask image information.

9. An image rasterizing method comprising:
inputting, by an input unit, an image file including plural first bitmap images having different image attributes or image file information acquired by converting the image file, the plural first bitmap images being drawn in accordance with a command;
by a bitmap image generating unit, creating a second bitmap image at least from the first bitmap image; and
by an attribute signal generating unit, searching attribute information held by the first bitmap image on the basis of the command, then deciding which data format of font data, vector data and bitmap data the first bitmap image corresponds to, in accordance with the attribute information, and generating an attribute signal indicating the decided data format.

10. The image rasterizing method according to claim 9, wherein in the generation of the attribute signal, which data format of font data, vector data and bitmap data the first bitmap image corresponds to is decided by applying the searched attribute information to a correspondence table that predefines corresponding relation between attribute information and data formats of font data, vector data and bitmap data.

11. The image rasterizing method according to claim 9, wherein the image file information is a page description language which is created from the image file and includes a command of bitmap data, and
the command is a command included in the page description language.

12. The image rasterizing method according to claim 9, wherein in the generation of the attribute signal, in the case where mask image information exists in the command, the attribute signal further including the mask image information is generated.

13. The image rasterizing method according to claim 9, wherein the attribute information is the number of bits, and
in the generation of the attribute signal, in the case where mask image information exists in the command, the attribute signal further including the mask image information is generated.

14. The image rasterizing method according to claim 9, wherein the attribute information is an image coding method, and
in the generation of the attribute signal, in the case where mask image information exists in the command, the attribute signal further including the mask image information is generated.

15. The image rasterizing method according to claim 9, wherein the attribute information is a color mode, and
in the generation of the attribute signal, in the case where mask image information exists in the command, the attribute signal further including the mask image information is generated.

16. The image rasterizing method according to claim 9, wherein the attribute information is the quantity of codes, and
in the generation of the attribute signal, in the case where mask image information exists in the command, the attribute signal further including the mask image information is generated.
